(19) United States
(12) Patent Application Publication
(10) Pub. No.: US 2015/0082695 A1
(43) Pub. Date: Mar. 26, 2015

(54) METHOD AND SYSTEM FOR EXTRACTING BUDS FROM A STALK OF A GRAMINACEOUS PLANT

(71) Applicant: BASF SE, Ludwigshafen (DE)

(72) Inventors: Harald Rödel, Mutterstadt (DE); Cassio da Silva Cardoso Teixeira, Sao Paulo (BR); Antonio Cesar Azenha, Ribeirao Preto (BR); Efraim Albrecht Neto, Campinas (BR); Domingos Guilherme Pellegrino Cerri, Piracicaba (BR)

(21) Appl. No.: 14/396,281

(22) PCT Filed: Apr. 22, 2013
(86) PCT No.: PCT/EP2013/058284

§ 371 Date: Oct. 22, 2014

Related U.S. Application Data
(60) Provisional application No. 61/638,505, filed on Apr. 26, 2012.

(30) Foreign Application Priority Data
Apr. 26, 2012 (EP) 12165637.5

(51) Int. Cl. A01G 3/00; B26D 5/00; A01G 1/00

(52) U.S. Cl. CPC A01G 3/00; A01G 1/001; B26D 5/007; A01G 2003/005
USPC 47/58.1 FV; 83/360; 83/365

(57) ABSTRACT

The present invention relates to a method for extracting buds 8 from a stalk 1 of a graminaceous plant comprising the steps of automatically detecting a bud 8 on the stalk 1 and cutting out a vegetal tissue comprising the bud 8 based on the detected position of the bud 8. According to the method the step of detecting the bud 8 on the stalk 1 comprises obtaining the longitudinal position of the bud 8 in the longitudinal direction of the stalk 1 and the circumferential angle position of the bud 8 on a cross section of the stalk 1, said longitudinal position and circumferential angle position defining the position of the bud 8. Furthermore, the invention relates to a system for carrying out this method as well as the use of this system for extracting buds 8 from a stalk 1 of a graminaceous plant.

The present invention relates to a method for extracting buds from a stalk of a graminaceous plant. The method comprises the steps of automatically detecting a bud on the stalk and cutting out a vegetal tissue comprising the bud based on the detected position of the bud. Furthermore, the present invention relates to a system for extracting buds from a stalk from a graminaceous plant. The system comprises a main detection device for detecting a bud and a main cutting device for cutting out a vegetal tissue comprising the bud. In particular, the invention relates to a method and a system for extracting buds from a sugar cane stalk.

The seed of sugar cane is a dry one-seeded fruit or caryopsis formed from a single carpel, the ovary wall pericarp being united with the seed-coat testa. The seeds are ovate, yellowish brown and very small, about 1 mm long. Disadvantageously, the seed of sugar cane only germinates under specific environmental characteristics, such as a constant warm and humid climate conditions. Such climatic conditions are not found everywhere sugar cane is grown and therefore germination of sugar cane seed is not always guaranteed. For commercial agriculture, the seed of a sugar cane is not sown or planted, but instead, the cane is propagated vegetatively by planting a stem segment or part of a stalk or culm or seedling.

The stem of sugar cane, as well as the stem of graminaceous plants, comprises sever-al nodes, from which new plants grow. The traditional planting process of sugar cane involves the reservation of an area of the crop to be used as a source of plants for re-planting, since the nodes are comprised in the stem. The plants used for replanting are harvested and then cut in segments of approximately 20 to 50 cm, so that at least two nodes are present in each stem segment sett. Cutting the stems is needed to break apical dominance that otherwise causes poor germination when using full length uncut stems. The segments are cut to have at least two buds or at least two nodes; every node gives generally rise to one single bud to assure germination, because not every bud germinates.

Current machines used to cut sugar cane segments are not able to identify any characteristic in the stem, and therefore the precise position of the cut sites is determined at random. After cutting, the setts, which have one or more nodes, are disposed horizon-tally, over one another in furrows of the ploughed soil, which are generally wide at ground level and deep 40 to 50 cm wide and 30 to 40 cm deep, and then lightly cov-ered with soil.

Although this plantation technique is still being used until today, the whole process is relatively inefficient because many segments of two to four nodes have to be used to guarantee the germination. The consequence is that a large area for re-planting needs to be used, and therefore area that could be employed for the crop and production of alcohol or sugar has to be reserved for re-planting. Thus, there is a necessity to increase the efficiency of the planting technique of sugar cane.

In a more recent cultivation method from Syngenta called Plene®, nodes of less than 4 cm in length are separated from the stems, treated with Syngenta seed products and then planted to the field. The method is said to lead to a yield increase of up to 15%. However, the area required for multiplication is still very large. Similar cultivation meth-ods are also described in WO 2009/000398, WO 2009/000399, WO 2009/000400, WO 2009/000401 and WO 2009/000402.

Furthermore, WO 2009/100917 describes a cutting machine and a method for cutting stem segments of a graminaceous plant. According to the method, a characteristic of the stem is identified using a sensor. The sensor is a pressure transducer sensor, a capacitive sensor, an ultrasound sensor, an X-ray sensor, a magnetic sensor or a mi-crowave sensor. The characteristic of the stem is in particular a node. After the node has been identified, the stem is placed in a determined position for cutting, depending on the response of the sensor. The stem is then cut at a particular position depending on the presence of the identified characteristic, i.e. the presence of a node. A similar method is described in WO 2009/100916.

Furthermore, CH 702011 A2 describes a further cutting device for sugar cane stalks. In this case, the sugar cane stalk is conveyed in the longitudinal direction to a node detection unit detecting the nodes of the stalk of the sugar cane. A cutting unit is connected to a control unit so that the cutting unit is activated if a node area is positioned within the cutting unit, thereby cutting out a node area.

Moreover, WO 86/06576 describes a method and an apparatus for dividing plant mate-rials. The method and apparatus relates to improvements in the micro propagation of plants. According to this method the plant is scanned to generate an image signal rep-resentative of the optically detectable structure. From the image signal, division loca-tions are determined and a corresponding division signal is generated. In particular, the image signal is processed to produce a co-ordinate map of the structure. Based on this co-ordinate map, branch tips and nodes are identified. A cutting machine is then activated responsive to the division signal to divide the plant material at the detected loca-tions.

It is the object of the present invention to provide a method and system for extracting buds from a stalk of a graminaceous plant, wherein buds are cut out together with meristematic tissue from the stalk so that the buds can subsequently be cultivated and wherein, however, as little material as possible is removed from the stalk.

According to the invention, this object has been achieved by a method as defined in claim 1 and a system as defined in claim 9. Further features of this method and system are defined in the dependant claims.

According to the method of the present invention, the step of detecting the bud on the stalk comprises obtaining the longitudinal position of the bud in a longitudinal direction of the stalk and the circumferential angel position of the bud on a cross section of the stalk, said longitudinal position and circumferential angel position defining the position of the bud.

In terms of the present invention, “stalk” or “stem” is the main trunk of the graminaceous plant, specifically a primary plant axis that develops buds and shouts. Usually, the stalk is essentially cylindrical. The cross section of the stalk is essentially ring-shaped having essentially a circular periphery. Furthermore, a longitudinal axis is defined to cross the centre of the ring shaped cross section of the stalk perpendicular. Preferably the stalk has at least a diameter of 40 mm.

“Node” is the location in the stalk where the shoot, bud or gemma is formed in a graminaceous plant.

“Shoot”, “bud” or “gemma” is the embryo, spore or germ of a graminaceous plant.

A “removed bud” or a “bud cut out” in the context of the present invention refers to a bud which also contains meristematic tissue. For example, this term includes a bud plus a small section of the node to which it is attached. This term does however not encompass the whole node with the bud. Typically, the removed bud is a “bud chip”, i.e. an essentially round or oval disc-shaped cutting of the stalk containing the bud and some meristematic tissue; typically of a diameter of ca. 1 to 5 cm, preferably 1 to 3 cm, more preferably 2 to 3 cm. Diameter in the context of an oval shape refers to the long-est extension of the oval. The bud chip may also have a square cross section. In this case, one edge is dimensioned of ca. 1 to 5 cm, preferably 1 to 3 cm, more preferably 2 to 3 cm, in particular the square cross section is dimensioned 20 mm×20 mm.

According to the method of the present invention not only the position of a bud in the longitudinal direction of the stalk is detected but also the angel position of the bud. As the vegetal tissue comprising the bud is cut out based on the longitudinal position of the bud as well as the circumferential angel position of the bud on the surface of the stalk, the extraction of the bud can be carried out more accurately.

Usually, only the longitudinal position of the bud is detected. Such detection may be sufficient if a whole node is cut out from the stalk. However, if only a part of the node, i.e. a vegetal tissue that comprises the bud and that contains meristematic tissue, is extracted and not the whole node it is important not only to detect the longitudinal position of the bud but also the circumferential angel position of the bud so that the vegetal tissue comprising the bud can exactly be cut out comprising as much vegetal tissue as necessary but as a little vegetal tissue as possible.

According to one embodiment, the step of detecting the bud on the stalk comprises irradiating the stalk with a laser beam and detecting the reflected electromagnetic radiation of the laser beam by an optical sensor. Therefore, the bud on the stalk is detected optically. In particular, the optical sensor may be a camera. Using a laser beam for detecting the bud provides a reliable and cost-effective detection method.

In particular, a laser line is irradiated on the surface of the stalk while the stalk moves in its longitudinal direction. The laser line extends perpendicular to the longitudinal direction of the stalk so that the stalk moves through a light curtain formed by the laser beam. Therefore, the laser beam scans the surface of the stalk while the stalk moves in its longitudinal direction.

In order to detect the whole surface of the stalk, the stalk may be irradiated with two or three or even more laser beams and two or more optical sensor may be used for detecting the reflected electromagnetic radiation of the laser beams.

According to a further embodiment, the step of detecting the bud on the stalk comprises computing the topography of the stalk based on the detected reflected electromagnetic radiation of the laser beam. As a bud forms a protrusion on the surface of the stalk, it may be reliably detected by analyzing the topography of the surface of the stalk.

According to a further embodiment, data indicating the detected position of the bud on the stalk are transferred to a main cutting device. The actual position of the bud relative to a fixed point in space is calculated based on the data indicating the detected position of the bud on the stalk and based on data indicating a movement of the stalk. Therefore, a movement of a stalk comprising a bud which position has been detected is measured so that the exact position of the bud can be calculated after the detection of the bud irrespective of any manipulations that are carried out with the stalk. Thus, data are available indicating at any time the position of the detected bud in space.

In particular, the position of the bud relative to a main cutting device is calculated based on data indicating the detected position of the bud on the stalk and based on data indicating movement of the stalk comprising the bud. Thus, the vegetal tissue comprising the bud may be cut out very accurately.

According to a further embodiment, the stalk or a segment of the stalk is positioned relative to the main cutting device based on data indicating the detected position of the bud on the stalk and based on data indicating a movement of the stalk so that vegetal tissue comprising the bud is cut out by the main cutting device. For example, the stalk or a stalk segment may be feed or positioned by a device that grips or fasts the stalk or the stalk segment into a defined position so that a vegetal tissue comprising the bud can be cut out accurately.

For example, the stalk segment or the stalk is feed to a turntable moving the stalk segment or the stalk to the main cutting device. The provision of a turntable may increase the yield and speed of the extraction of the buds.

According to a further embodiment, the step of cutting out the vegetal tissue comprising the bud comprises punching out a vegetal tissue in the direction of a straight line that passes trough the centre of the stalk and the position of the centre of the bud on the surface of the stalk. The axis of the punching action coincides therefore with the radial direction of the stalk crossing the centre of the bud on the surface of the stalk.

It is noted that the circumferential angel positions of the buds on one stalk is not always the same. Therefore, the straight line that passes through the centre of the stalk and through the position of the centre of the bud on the surface of the stalk is not the some for all buds of one stalk. The angel of the straight line may vary for different buds on the stalk. Therefore, according to an embodiment of the invention, the stalk and a punching device may be rotated relative to each other around the longitudinal axis of the stalk so that the axis of the punching device, i.e. the direction in which the blade of the punching device is moved, coincides with the straight line that passes through the centre of the stalk and through the position of the centre of the bud. In other words, the axis of the punching action coincides with the radial direction of the stalk crossing the centre of the bud on the surface of the stalk. By this measure the vegetal tissue comprising the bud can be extracted as exactly as possible.

In order to cut out as less vegetal tissue as possible, but as much tissue as necessary, the extension of the vegetal tissue that is punched out is smaller than the cross section dimension of the stalk. However, the extension of the vegetal tissue punched out comprises the whole bud and enough meristematic tissue that is necessary for cultivating the graminaceous plant from the bud. In particular, the vegetal tissue punched out is thus not comprised the whole note comprising the bud.

However, it is imperative that the buds are removed in such away that the removed buds comprise meristematic tissue. The meristematic tissue is known to those skilled in the art and can be located by its position close to the node. The presence of meristematic tissue enables the removed buds to form roots and produce seedlings. For this purpose the buds are removed close to the node from which they originate and preferably comprise or, in other words, are attached to a part of the node.

The present invention further relates to a system for extracting buds from a stalk of a graminaceous plant comprising a detection device for detecting a bud on a stalk and a main cutting device for cutting out a vegetal tissue comprising the bud based on the detected position of the bud. The detection device of the system according to the present invention comprises an analyzing unit for computing the longitudinal position of the bud in the longitudinal direction of the stalk and the circumferential angel position of the bud on the stalk, said longitudinal position and circumferential angel position defining the position of the bud.

In particular, the system of the present invention is adapted to carry out the above-mentioned method of the present invention. It provides therefore the same advantages as the method of the present invention.

According to an embodiment of the system of the present invention the detection device comprises a laser unit for irradiating the stalk with a laser beam. Furthermore, the detection device comprises at least one optical sensor for detecting the reflected electromagnetic radiation of the laser beam. In this case, the analyzing unit may be adapted to compute the position of the bud by analyzing the topography of the stalk surface based on the detected reflected electromagnetic radiation of the laser beam. In order to analyze the whole circumferential surface of the stalk simultaneously two or more laser devices and optical sensors may be used.

In particular, the optical sensor may be a camera, preferably a camera obtaining images that may be analyzed using laser triangulation for extracting the shape of the surface of the stalk.

According to a further embodiment, the system further comprises a conveyer for conveying the stalk to the main detection device, said conveyer comprising pressure rollers urging the stalk in a straight line. Therefore, any curve of the stalk may be corrected. The extension of a stalk may deviate from an ideal straight line. However, an exact detection of the position of a bud can be carried out more accurately if the stalk is straight. Therefore, the system of the present invention may provide straight stalks if the stalks are originally not straight.

Alternatively said conveyer comprises grips that secure the stalk and conduct it up further to the detection and/or extraction of the buds. In this case the risk is avoided that the stalk can move from is original position after the first punch or may lose its integrity, creating debris and making it impossible to continue in the rollers. Therefore a fas-tening or gripping mechanism may be advantageous.

According to a further embodiment, the system comprises a further cutting device having a blade that is moved in a direction perpendicular to the longitudinal axis of a stalk for transversely cutting the stalk into stalk segments.

According to a further embodiment, the system comprises an apparatus that grips or fasts the stalk or stalk segment into a defined position so that a vegetal tissue comprising the bud can be cut out accurately. In particular, the system comprises a turntable for rotating the stalk or the stalk segments to the main cutting device.

According to a further embodiment, the main cutting device is a punching device. In particular, the stalk and the punching device may be rotated relative to each other around the longitudinal axis of the stalk so that the axis of the punching device, i.e. the direction in which the blade of the punching device is moved, coincides with a straight line that passes through the centre of the stalk and through the position of the centre of the bud. In order to cut out as less vegetal tissue as possible, but as much tissue as necessary, the extension of the blade of the punching device is smaller than the cross section dimension of the stalk. However, the extension of the blade is sufficient to cut out vegetal tissue that comprises the whole bud and enough meristematic tissue that is necessary for cultivating the graminaceous plant from the bud.

The present invention further relates to the use of the above-described system for extracting buds from a stalk of a graminaceous plant, in particular a stalk of an adult sugar cane plant.

Embodiments of the present invention are now describes with reference to the figures.

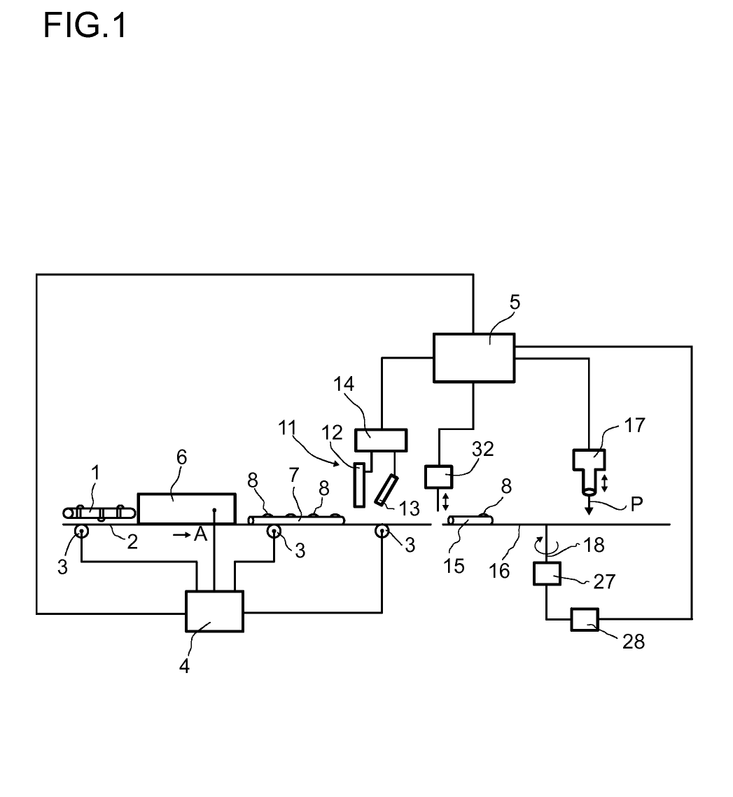

FIG. 1 shows schematically the structure of an embodiment of the system for extracting buds from a stalk according to the present invention;

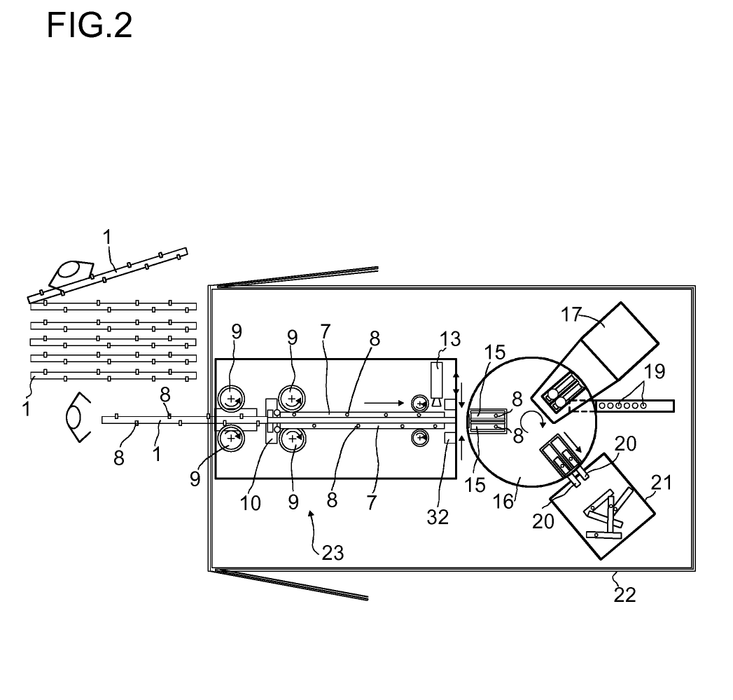

FIG. 2 shows a top view of a variant of the embodiment of the system shown in FIG. 1 for extracting buds from a stalk according to the present invention;

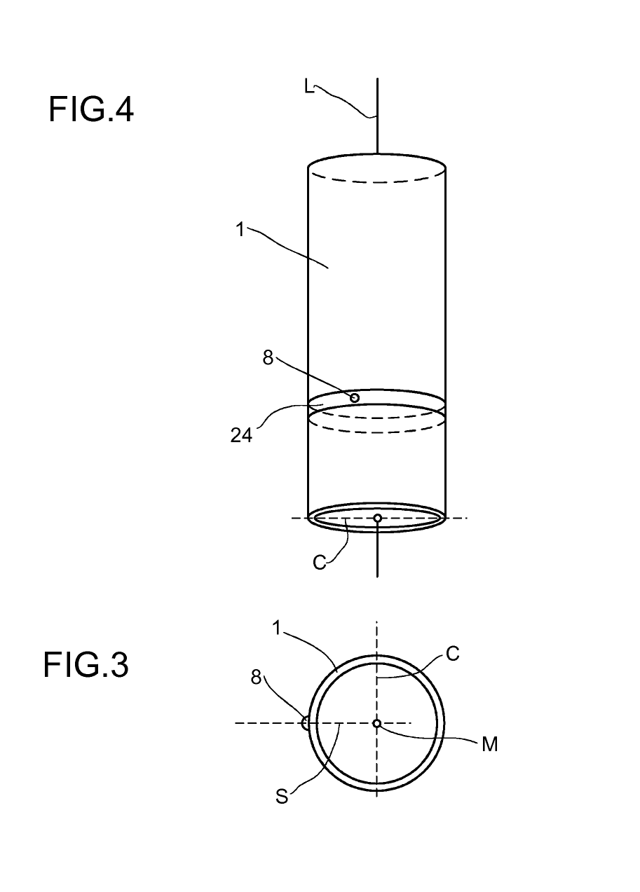

FIG. 3 shows a cross section of a stalk with a bud;

FIG. 4 shows a perspective view of the stalk shown in FIG. 3

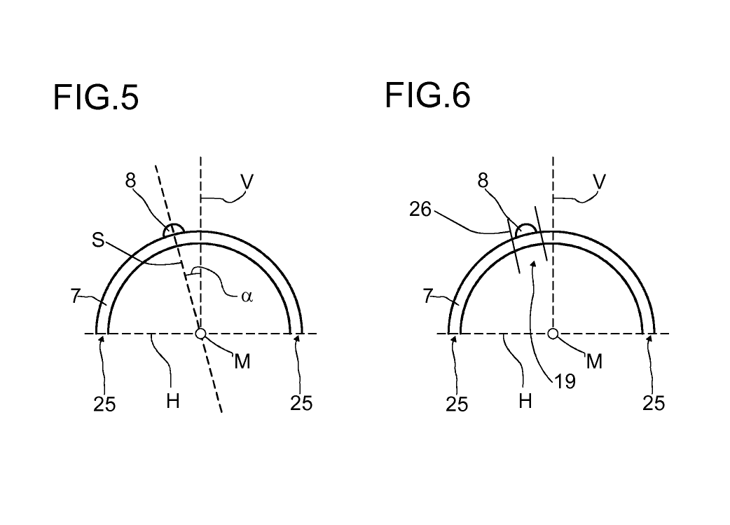

FIG. 5 shows a cross section of a stalk half;

FIG. 6 shows the stalk half shown in FIG. 5 and a blade of a punching device;

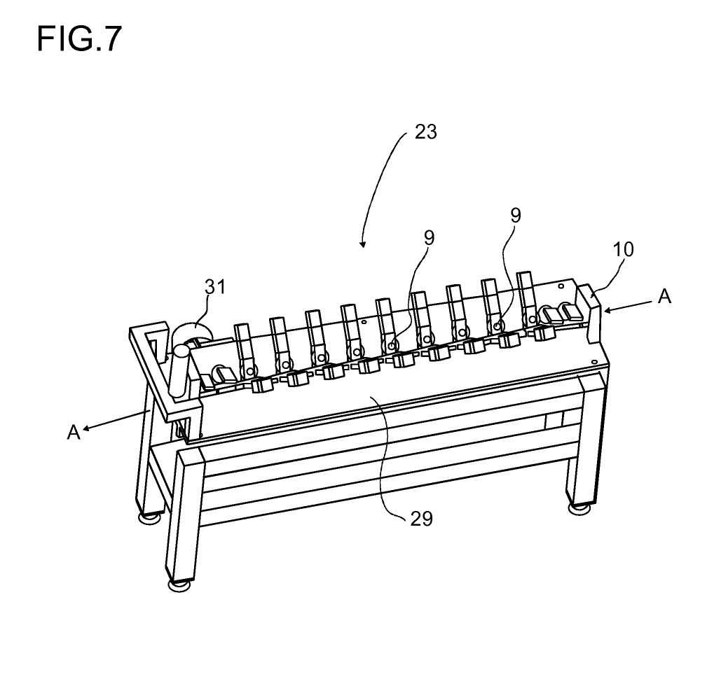

FIG. 7 shows a perspective view of a part of the system shown in FIG. 2; and

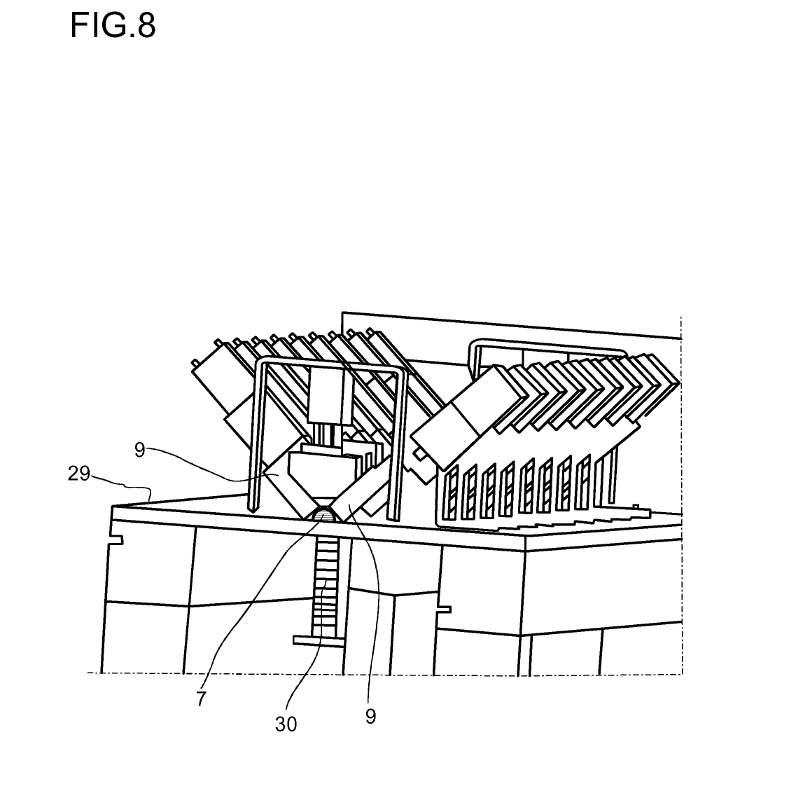

FIG. 8 shows another perspective view of a part of the system shown in FIG. 2.

The first embodiment of the system and the method of the present invention is now described with reference figures:

Sugar cane plants are removed by chopping off with a machete in a height of approximately 2 m to 2.5 m. The removed top part of the sugar cane plants is disregarded. The below, remaining stalks are removed from the field by cutting them off closely above the ground. The stalks are cleaned and prepared for the extraction of the buds.

As shown in FIG. 1, such stalk 1 is placed on a conveyer. The conveyer comprises a belt 2 and drive rollers 3 for conveying the stalk 1 in direction A. The drive rollers 3 are controlled by a conveyer control unit 4. The conveyer may move stalks 1 without slip-page.

In the variant of the first embodiment shown in FIG. 1 the stalk 1 is placed on the beginning of the conveyer. By the transport of the conveyer the stalk 1 then enters an initial detection and cutting device 6. The initial detection and cutting device 6 is connected with the conveyer control unit 4 and a signal indicating that a stalk 1 enters the initial detection and cutting device 6 is transferred to the conveyer control unit 4.

The conveyer control unit 4 transfers data indicating the position of each stalk 1 on the conveyer to a main control unit 5. Therefore, main control unit 5 comprises data indicating at each time the position of each stalk 1 on the conveyer.

The initial detection and cutting device 6 firstly detects the position of the buds of stalk 1 roughly. In particular, only the circumferential angel position is roughly detected.

Usually the stalk 1 comprises nodes that are ring shaped and spaced apart from each other in the longitudinal direction of the stalk 1. Each node comprises one bud 8. The buds 8 of consequent nodes are located approximately on opposite directions of the stalk 1. Therefore, every second bud 8 extends approximately in the same first direction and every second other bud 8 extends in another direction being 180° apart from the first direction.

FIGS. 3 and 4 show a cross section and a perspective view of a stalk 1. However, the stalk 1 is only shown partly comprising one node 24 including one bud 8. The stalk 1 is cut in longitudinal direction L at plane C that is perpendicular to straight line S that passes through the centre M of the stalk 1 and the position of bud 8. However, it is mentioned that not all buds have the same circumferential angel position on the surface of stalk 1 so that every straight line S of each bud 8 is exactly perpendicular to plane C.

The initial detection and cutting device 6 rotates stalk 1 relative to an initial cutting device so that stalk 1 is cut into two halves 7 in the direction of plane C. The cross section of one half 7 is shown in FIG. 5.

The stalk halves 7 are then automatically placed on the conveyer so that the stalk halves 7 are placed adjacent to each other and oriented so that the cut faces of both halves 7 are oriented downwards. Accordingly, the buds 8 on each stalk half 7 are oriented essentially upwards.

FIG. 2 shows another variant of the first embodiment of the system of the present invention. It is similar to the variant shown in FIG. 1. However, it does not comprise an initial detection and cutting device 6 but only an initial cutting device 10. Initial cutting device 10 comprises a cutting blade that is oriented vertically in the longitudinal direction of the stalks 1 for cleaving stalks 1. In this case a user feeds the stalks 1 in a particular orientation to the initial cutting device 10 so that the buds extends to the right and to the left so that the stalks 1 are cleaved in a plane that corresponds to plane C shown in FIGS. 3 and 4. Therefore, the embodiment shown in FIG. 2 only differs from the embodiment shown in FIG. 1, in that the orientation of the cut of the stalk 1 in longitudinal direction L of the stalk 1 is not determined automatically but manually. Therefore, the following description of the embodiment is the same for both variants so that reference is made to FIG. 1 as well to FIG. 2.

The stalk halves 7 are then conveyed further in direction A whereby the stalk halves 7 are urged by pressure rollers 9 essentially in a straight line.

The stalk halves 7 are then feed to main detecting device 11. Main detecting device 11 comprises a laser unit 12, an optical sensor 13, for example a camera, and an analyzing unit 14 that is connected to the laser unit 12 and the optical sensor 13.

The laser unit 12 irradiates the upper surface of stalk halves 7 with a laser beam. In particular, the laser beam may irradiate a line on the upper surface of the stalk halves 7 in transverse direction while the stalk halves 7 move in its longitudinal direction L so that the laser beam scans the upper surfaces of the stalk halves 7. In the present embodiment the laser unit 12 irradiates a red laser line vertically down on the upper surface of stalk halves 7.

In the present embodiment, the optical sensor 13 is a camera. It detects visual images of the electromagnetic radiation of the laser beam reflected by the upper surface of the stalk halves 7. The images are transferred to analyzing unit 14 that is able to compute the three-dimensional shape of the surface of stalk halves 7. In particular, the topography of the surface of the stalk halves 7 are computed by a pixel-by-pixel analysis of the detected reflected electromagnetic radiation of the laser beam. The topography may for example be computed according to the laser triangulation principal.

Alternatively or in addition the colour variation of the surface of the stalk halves 7 may be analyzed. Furthermore, thermography may be used to analyze the surface of the stalk halves 7.

The topography computed by the analyzing unit 14 is further analysed so that a bud 8 on a stalk half 7 is identified. Subsequently, the position of the bud 8 in longitudinal direction L is determined as well as the circumferential angel position α of the bud 8 on the cross section of the stalk half 7. The position of the bud 8 in the longitudinal direction L and the circumferential angel position α of the bud 8 on the cross section of the stalk 7 define the position of the bud 8 on the stalk half 7. As mentioned above, the position of the bud 8 is not always exactly vertically over the centre M of the stalk 1 that has formed stalk half 7 so that the circumferential angel position α of the buds 8 of one stalk half 7 vary.

FIGS. 5 and 6 show the definitions of the position of a bud 8 on the surface of a stalk half 7. Stalk half 7 is oriented so that the cut faces 25 lay on a horizontal plane H that is identical to plane C. Furthermore, a vertical line V is shown that extends perpendicular to horizontal plane H and crossing centre M of stalk 1 and stalk half 7. The circumferential angel position α of bud 8 is defined as the angel on a cross section of stalk half 7 between a straight line S passing centre M and the centre position of bud 8 on the one hand and the vertical line V on the other hand as shown in FIG. 5.

FIGS. 7 and 8 show a more detailed view of section 23 of the system described with reference to FIGS. 1 and 2. However, an embodiment is shown that processes the stalk halves 7 sequentially and not next to each other as described above. However, all features shown in FIGS. 7 and 8 may also be used in connection with the parallel processing of stalk halves 7 as described above.

As shown in detail in FIGS. 7 and 8, the stalk halve 7 oriented so that the cut faces 25 show downwards is supported by toothed wheels 30 that may be driven by motor 31. Motor 31 is controlled by control unit 4. The toothed wheels 30 transport the stalk halves 7 in direction A. Furthermore, it can be seen in particular in FIG. 8 that multiple pressure rollers 9 urge stalk half 7 in a straight line. Multiple pressure rollers 9 are mounted on a machine table 29 that comprises a recess so that the toothed wheels 30 may support stalk halves 7.

Returning to FIGS. 1 and 2, data as to the position of a detected bud 8 on a stalk half 7, i.e. the longitudinal position and the circumferential angel position α, are transferred from the analysing unit 14 to main control unit 5. Once, a bud 8 has been detected on the right stalk half 7 as well as the left stalk half 7, main control unit 5 controls the drive rollers 3 or toothed wheels 30 of the conveyer so that the stalk halves 7 are moved relative to each other in the longitudinal direction L so that the detected buds 8 of the stalk halves 7 are positioned next to each other.

Subsequently, both stalk halves 7 are further feed on conveyer to a further cutting device 32. Cutting device 32 cuts stalk halves 7 positioned next to each other into stalk segments 15, so that each segment 15 comprises only one bud 8. As shown in FIG. 2 buds 8 of adjacent stalk segments 15 are positioned next to each other. The length of a stalk segment 15 corresponds approximately to the distance of two buds 8 in the longitudinal direction L.

In general, the stalk segments 15 are then feed or positioned by a device that grips or fasts the stalk segments 15 into a defined position with respect to a main cutting device. In the present case, stalk segments 15 are feed to a turntable 16. Turntable 16 comprises a motor 27 that can rotate turntable 16 around vertical axis 18. The rotation of turntable 16 is controlled by the turntable control unit 28 that transfers data indicating as to how turntable 16 is rotated to main control unit 5. Therefore, main control unit 5 may determine the position of stalk segments 15 as well as the position of buds 8 at any time.

As it can be seen in FIG. 2, main control unit 5 turns turntable 16 so that stalk segments 15 are moved to a punching device 17 that forms in the embodiment the main cutting device. If buds 8 of stalk segments 15 are positioned directly under punching device 17 the main control unit 5 stops turntable 16. The punching device 17 comprises a unit that grips and fasts stalk segments 15. Based on data indicating the circumferential angel position α of each bud 8 on each stalk segment 15, each stalk segment 15 is rotated around the longitudinal axis L by the griping and fasting unit of the punching device 17 so that each bud 8 is exactly oriented vertically upwards. In other words, the straight line S passing the centre M of stalk segment 15 and the centre position of bud 8 is oriented vertically. Two tubular blades 26 of punching device 17 are then moved vertically downwards to punch out a vegetal tissue 19 comprising the bud 8. Therefore, a so-called “bud chip” 19 is cut out from each stalk segment 15.

As two stalk segments 15, each comprising one bud 8, are positioned next to each other, each stroke of punching device 17 results in two bud chips that are cut out and that are collected.

According to another variant of the first embodiment not the stalk segments 15 are rotated around the longitudinal axis L relative to the punching device 17 but the axis P of each blade 26 of punching device 17 is rotated relative to each stalk segment 15 around the axis L of the respective stalk segment 15 so that the axis P of each blade 26 of punching device 17 coincides with the straight line S crossing the centre M of stalk segment 15 and the centre position of the bud 8. This rotation of the tubular blades 26 of punching device 17 is also controlled by main control unit 5 based on the circumferential angel position α of each bud 8 on stalk segments 15. As shown in fig-ure 6, the tubular blade 26 cuts out the bud chip 19.

It is pointed out that the extension of the bud chips 19 is much smaller than the extension of the cross section of a stalk half 7. However, each bud chip 19 contains the bud 8 and meristematic tissue. In particular, the extracted bud 8 is not bound to the complete node 24 from which it originates, but just to a small disc- or chip-like portion of the stalk 1. As the punching device 17 is moved in the radial direction of the stalk 1, even if stalk 1 comprises buds 8 that are not exactly oriented parallel, the method and the system of the present invention provides bud chips 19 that have cut faces oriented perpendicular to a tangent on the surface of a cylindrical representation of the stalk 1 at the position of the bud 8.

The punching device 17 may use a pneumatic or a light puncher. Furthermore, a laser beam may be used for cutting out bud chips 19.

As shown in FIG. 2, after cutting out bud chips 19 turntable 16 is further rotated to move the rest 20 of stalk segments 15 from which the bud chips 19 have been cut out to a container 21. Container 21 feeds the rest 20 of the stalks 1 to a mill for crushing the rest 20 of stalks 1. Therefore, the remaining stalks 1 are made available for further processing.

The whole system shown in FIG. 2 is arranged within a 20 ft. standard sea container 22 so that the system may easily be transported to the desirable location for extracting the buds 8.

The above-described method and system is used to extract buds 8 from adult sugar cane stalks 1. However, buds 8 from stalks 1 of other graminaceous plants may also be extracted using the method and system described above.

In the following, a second embodiment of the system and the method of the present invention is described:

The second embodiment differs from the above-described first embodiment in that the stalk 1 is not cut in the longitudinal direction into stalk halves 7, but stalk 1 is processed as a whole. It may only cut transversely into segments but not longitudinally. Therefore, the system according to the second embodiment does neither comprise the initial detection and cutting unit 6 nor the initial cutting unit 10. Instead the whole stalk 1 is urged by pressure rollers 9 into a straight line and feed to the main detection unit 11.

However, the main detection unit 11 of the second embodiment differs from the main detection unit 11 of the first embodiment in that more than one laser unit 12 and more than one optical sensor 13 are used so that the surface of the stalk 1 may be analyzed on the whole circumference. For example, three lasers units 12 and optical sensors 13 may be used that are positioned around stalk 1 on the conveyer. Alternatively, the main detection unit 11 is identical to detection unit 11 of the first embodiment but during detection the stalk 1 is rotated around the longitudinal axis L so that buds 8 may be detected irrespective of its circumferential angel position. Such rotation of stalk 1 during detection by the main detection unit 11 is also detected and data thereto are transferred to main control unit 5. Therefore, the longitudinal position as well as the circumferential angel position α of all buds 8 on stalk 1 can be identified and transferred to punching device 17.

Furthermore, the step of moving the stalks 1 in a longitudinal direction L so that the detected buds 8 are positioned next to each other is omitted as in this case two stalks 1 are not positioned next to each other.

According to the second embodiment, a stalk segment is formed by cutting device 32, too, and the stalk segment is rotated on turntable 16 around its longitudinal axis L so that the straight line S crossing the centre M of stalk 1 and the centre position of bud 8 is exactly orientated vertically. Therefore, vertical movement of a blade 26 of punching device 17 cuts out one bud chip 19.

Alternatively, punching device 17 may be rotated around the longitudinal axis L of the stalk 1. In this case the part of the stalk 1 that comprises bud 8 may overlap turntable 16 and the punching device 17 itself supports stalk 1 on the side opposite to the position of bud 8 when punching out bud chip 19.

All other steps described with reference to the first embodiment may also be carried out analogously in the second embodiment of the system and method of the present invention.

It is mentioned that the method and system according to the present invention have high throughput using rather lightweight and simple equipment so that it can be placed into a mobile container 22. This system can therefore be used for extraction of the buds on the side of the mill that process the rest 20 of the stalk 1.

### LIST OF REFERENCE SIGNS

1 stalk
2 belt
3 drive rollers
4 conveyer control unit
5 main control unit
6 initial detection and cutting device
7 stalk half
8 bud
9 pressure rollers
10 initial cutting device
11 main detection unit
12 laser unit
13 optical sensor, camera
14 analyzing unit
15 stalk segment
16 turntable
17 punching device
18 axis
19 bud chips, vegetal tissue with bud
20 rest of stalk
21 container
22 standard sea container
23 section of the system
24 node
25 cut faces
26 blade of punching device
27 motor
28 turntable control unit
29 machine table
30 toothed wheels
31 motor
32 cutting device

1. A method for extracting buds from a stalk of a graminaceous plant comprising:
automatically detecting a bud on the stalk; and
cutting out a vegetal tissue comprising the bud based on the detected position of the bud,
wherein the step of detecting the bud on the stalk comprises obtaining the longitudinal position of the bud in the longitudinal direction of the stalk and the circumferential angle position of the bud on a cross section of the stalk, said longitudinal position and circumferential angle position defining the position of the bud.

2. The method according to claim 1, wherein the step of detecting the bud on the stalk comprises irradiating the stalk with a laser beam and detecting the reflected electromagnetic radiation of the laser beam by at least one optical sensor.

3. The method according to claim 1, wherein a laser line is irradiated on a surface of the stalk while the stalk moves in its longitudinal direction.

4. The method according to claim 2, wherein the step of detecting the bud on the stalk comprises computing a topography of the stalk based on the detected reflected electromagnetic radiation of the laser beam.

5. The method according to claim 1, wherein the position of the bud relative to a main cutting device is calculated based on data indicating the detected position of the bud on the stalk and based on data indicating movement of the stalk comprising the bud.

6. The method according to claim 1, wherein the stalk or a segment of the stalk is positioned relative to the main cutting devise based on data indicating the detected position of the bud on the stalk and based on data indicating movement of the stalk so that vegetal tissue comprising the bud is cut out by the main cutting device.

7. The method according to claim 1, wherein the step of cutting out the vegetal tissue comprising the bud comprises punching out vegetal tissue in the direction of a straight line that passes through the centre of the stalk and the position of the centre of the bud on the surface of the stalk.

8. The method according to claim 7, wherein, before cutting out the vegetal tissue, the stalk and a punching device are rotated relative to each other around the longitudinal axis of the stalk so that the axis of the punching device coincides with a straight line on a cross section of the stalk that passes through the center of the stalk and the position of the center of the bud on the surface of the stalk.

9. A system for extracting buds from a stalk of a graminaceous plant comprising:
a main detection device for detecting a bud on a stalk; and
a main cutting device for cutting out a vegetal tissue comprising the bud based on the detected position of the bud,
wherein the main detection device comprises an analysing unit for computing the longitudinal position of the bud in the longitudinal direction of the stalk and the circumferential angle position of the bud on the stalk, said longitudinal position and said circumferential angle position defining the position of the bud.

10. The system according to claim 9, wherein the detection device comprises at least one laser unit for irradiating the stalk with a laser beam.

11. The system according to claim 10, wherein the main detection device comprises at least one optical sensor for detecting a reflected electromagnetic radiation of the laser beam.

12. The system according to claim 9, further comprising a conveyer for conveying the stalk to the main detection device, said conveyer comprising pressure rollers urging the stalk in a straight line.

13. The system according to claim 9, wherein the main cutting device and the stalk comprising the bud are rotatable relative to each other.

14. The system according to claim 9, wherein the main cutting device is a punching device.

15. (canceled)

16. The system according to claim 11, wherein the at least one optical sensor comprises a camera.

17. The system according to claim 9, where the system comprises a second cutting device, the cutting device having a blade that is moved in a direction perpendicular to a longitudinal axis of the stalk for transversely cutting the stalk into stalk segments.

18. The system of claim 12, wherein the conveyer comprises grips that secure the stalk half.

19. The system according to claim 9, further comprising an initial detection device for automatically detecting the proximate position of the bud on the stalk.

20. The system according to claim 9, further comprising a turntable for rotating the stalk to the main cutting device.
